(19) United States
(12) Patent Application Publication
(10) Pub. No.: US 2006/0087836 A1
(43) Pub. Date: Apr. 27, 2006

(54) Portable lighting assembly for automotive vehicle

(76) Inventors: Steven E. Morris, Fair Haven, MI (US); Frederick I. Johnson, Birmingham, MI (US)

Correspondence Address: LAURA C. HARGITT;General Motors Corporation, Mail Code 482-C23-B21, P.O. Box 300, Detroit, MI, 48265-3000, US

(21) Appl. No.: 10/976,085

(22) Filed: Oct. 27, 2004

(51) Int. Cl. F21V 33/00

(52) U.S. Cl. 362/155; 362/489

(57) ABSTRACT

The present invention concerns a portable lighting assembly for an automotive vehicle having a container that includes a moveable door operable to close the container, a light housing mount, and at least one electrical contact connected to a vehicle electric system. The portable lighting assembly includes a light housing having a light and an element for operatively engaging the at least one electrical contact in the container and a power source disposed in the housing that is selectively electrically connected to the light and the element in the light housing. The light housing is removably mounted to the housing mount and has a switch operatively engaging the power source. The switch is operable to deenergize the light when the door is in a closed position and energize the light when the door is in an open position.

### BACKGROUND OF THE INVENTION

The present invention relates generally to automotive vehicle lighting systems and, in particular, to a portable lighting assembly for an automotive vehicle.

Vehicle electrical systems for providing light to containers such as a glove box, a trunk, an engine compartment and the like are well known. There are often times, however, where it is desirable to provide light external from the vehicle. Battery-powered flashlights are desirable in such a situation but it is often difficult to find a good storage location in the vehicle for the flashlight. If there is no fixed storage location, locating the flashlight when needed can be especially difficult.

It is desirable, therefore, to provide a portable lighting assembly for an automotive vehicle that may be removably mounted to a container in the vehicle.

### SUMMARY OF THE INVENTION

The present invention concerns a portable lighting assembly for an automotive vehicle having a container that includes a moveable door operable to close the container, a light housing mount, and at least one electrical contact connected to a vehicle electric system. The portable lighting assembly includes a light housing having a light and an element for operatively engaging the at least one electrical contact in the container and a power source disposed in the housing that is selectively electrically connected to the light and the element in the light housing. The light housing is removably mounted to the housing mount and has a switch operatively engaging the power source. The switch is operable to deenergize the light when the door is in a closed position and energize the light when the door is in an open position.

The portable lighting assembly in accordance with the present invention advantageously provides illumination to a container of a vehicle such as, but not limited to, a glove box, a trunk, an engine compartment, or the like when mounted in the light housing mount. The portable lighting assembly also preferably includes an override switch disposed in the light housing that is operable to selectively energize the light and disable the switch in an engaged position and deenergize the light and enable the switch in a disengaged position. When the portable lighting assembly is removed from the light housing mount, the override switch advantageously functions as an off/switch to selectively energize and deenergize the light.

The portable lighting assembly in accordance with the present invention is always mounted in the same location, allowing the portable lighting assembly to be found easily. Preferably, the portable lighting assembly includes a rechargeable battery that is connected to the vehicle electrical system, reducing the need to replace the batteries therein.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a perspective view of a portable lighting assembly in accordance with the present invention shown disposed in a container;

FIG. 2 is a perspective view of the portable lighting assembly of FIG. 1;

FIG. 3 is a schematic view of the portable lighting assembly of FIGS. 1 and 2; and

FIG. 4 is a schematic view of an alternative embodiment of a portable lighting assembly in accordance with the present invention.

### DESCRIPTION OF THE PREFERRED EMBODIMENT

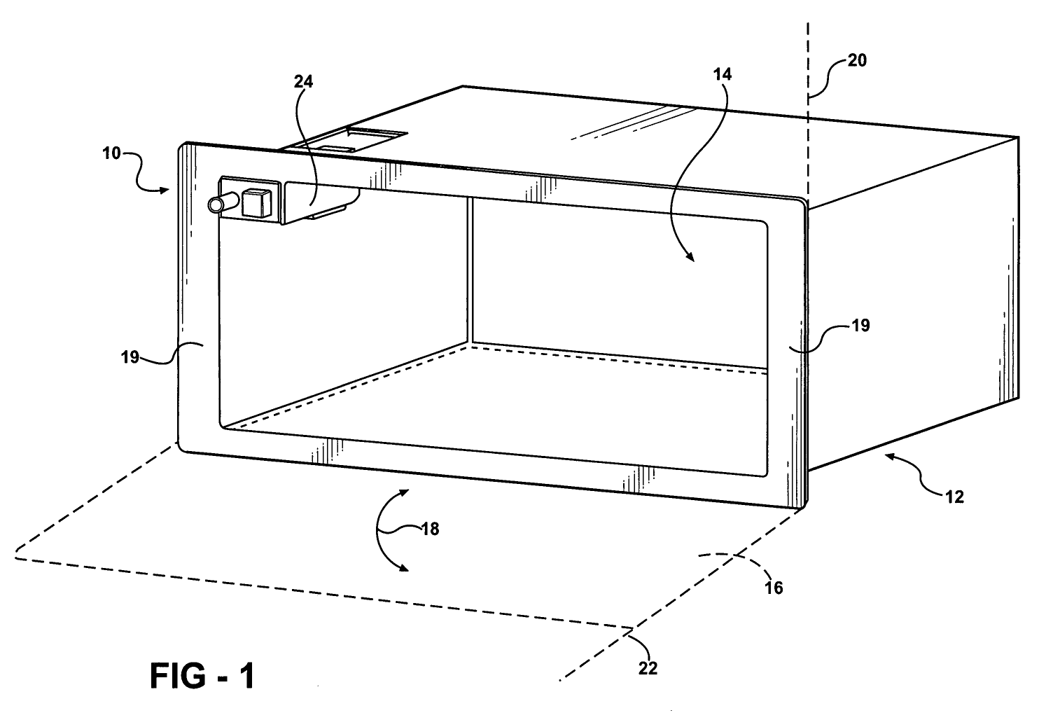

Referring now to FIG. 1, a portable lighting assembly in accordance with the present invention is indicated generally at 10. The portable lighting assembly 10 is adapted to be removably mounted in a compartment or container, indicated generally at 12. The container 12 defines an interior space 14 therein and may be one of, but is not limited to, a glove box, a trunk, an engine compartment, or the like, as will be appreciated by those skilled in the art. The container 12 includes a movable door 16 that is operable to move in a direction indicated by an arrow 18 between a closed first position, indicated by an arrow 20, to an open second position, indicated by an arrow 22, wherein the door 16 exposes the interior space 14. When in the closed position 20, an inner surface of the door 16 comes into contact with a face 19 of the container 12 and closes the container 12 and a latching means (not shown) is utilized to keep the door 16 in the closed position 20. The container 12 includes a light housing mount 24 disposed in the interior space 14 for releasably receiving the portable lighting assembly 10. The light housing mount 24 may be located to cause an interference fit with the portable lighting assembly 10 to thereby retain the portable lighting assembly 10. Alternatively, the light housing mount 24 may include a separate retaining member (not shown) disposed therein for retaining the portable lighting assembly 10 in the light housing mount 24. The retaining member may be, but is not limited to, a spring-biased clip, a latch, or any other type of retaining device operable to releasably retain the portable lighting assembly 10 in the light housing mount 24, as will be appreciated by those skilled in the art. The container 12 also includes at least one electrical contact disposed therein, preferably in or adjacent the light housing mount 24, discussed in more detail below.

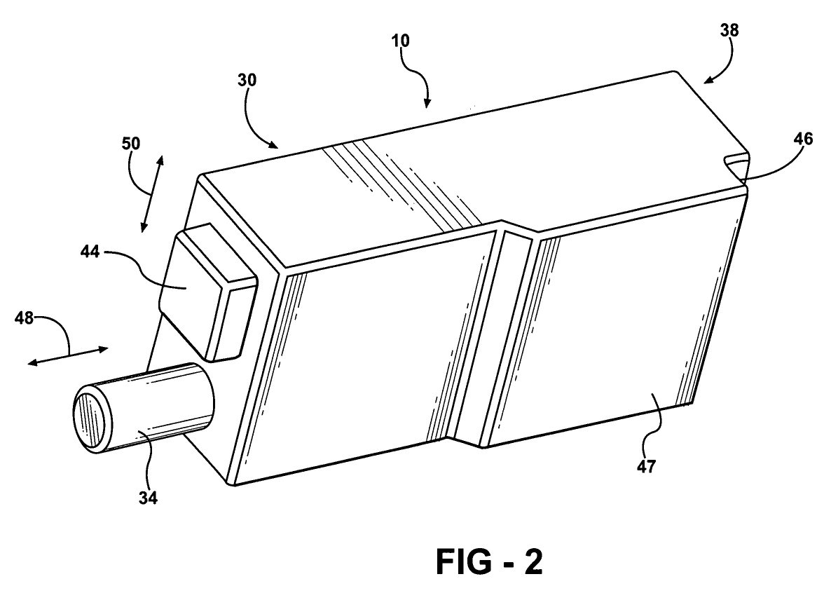

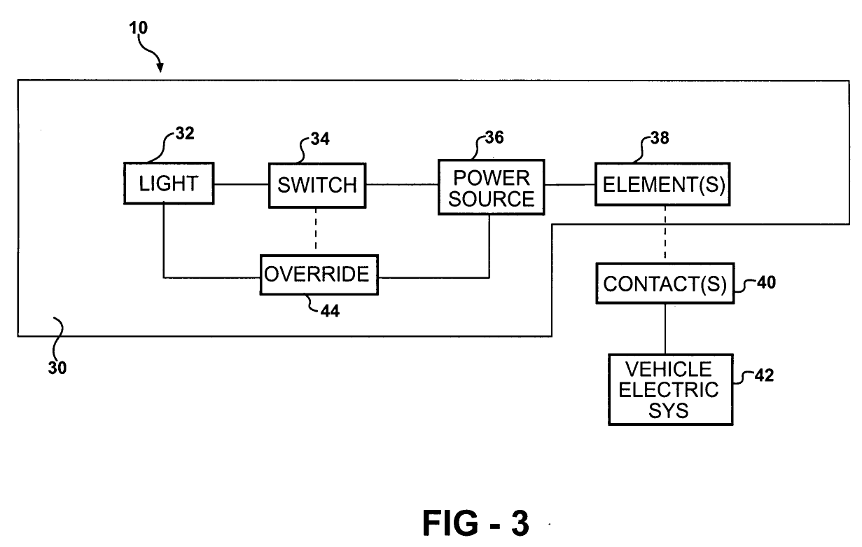

Referring now to FIG. 2-3, the portable lighting assembly 10 includes a light housing 30 having a light 32 disposed therein. The light housing 30 is sized to be removably mounted to the light housing mount 24. The light 32 may be any type of illumination device including, but not limited to, an incandescent bulb, a fluorescent bulb, at least one light emitting diode (LED) or the like. The light 32 is electrically connected to a switch 34, which is in turn electrically connected to a power source 36, such as a rechargeable battery or the like. Preferably, the battery 36 is operable to be removed from the housing 30 and replaced during routine maintenance or the like. The battery 36 is also connected to an element 38 that operatively engages the at least one electrical contact 40 in the light housing mount 24. Preferably, the element 38 is located on a rear portion of the light housing 30, best seen in FIG. 2. The electrical contact 40 is also connected to a vehicle electrical system 42, which provides power to the battery 36 through the contact 40 and the element 38 and advantageously recharges the battery 36 while the portable light assembly 10 is mounted in the light housing mount 24. An override switch 44 is disposed in the light housing 30 and is electrically connected to the light 32 and the battery 36. Alternatively, the override switch 44 is a sliding button that mechanically engages with the switch 34, discussed in more detail below. The light housing 30 preferably includes a detent, a ridge or a lip 46 on a rear portion thereof adjacent the element 38, best seen in FIG. 2, for engaging with the retaining member of the light housing mount 24 to removably mount the light housing to the light housing mount 24. The light housing 30 preferably includes a lens 47 attached thereto. The lens 47 is preferably located adjacent the light 32 and diffuses light when the light 32 is energized, discussed in more detail below, and also protects the light 32 from foreign object damage.

The switch 34 is preferably a spring-biased pushbutton that is operable to be moved in a direction indicated by an arrow 48, best seen in FIG. 2. The switch 34 selectively electrically connects the battery 36 and the light 32. When moved in the direction 48 toward the light housing 30, such as when the door 16 is moved in the direction 18 to the closed position 20 and a free end of the switch 34 engages with an inner surface of the door 16, the spring (not shown) of the switch 34 compresses. In this position, the switch 34 does not electrically connect the power source 36 and the light 32 and thus deenergizes the light 32. When moved in the direction 48 away from the light housing 30, such as when the door 16 is moved in the direction 18 to the open position 22, the spring of the switch 34 decompresses and moves the switch 34 to an extended position shown in FIG. 2. In this position, the switch 34 electrically connects the battery 36 and the light 32, and thus energizes the light 32 to provide illumination to the interior space 14 of the container 12.

The override switch 44 is movable in a direction indicated by an arrow 50, best seen in FIG. 2, between an engaged position and a disengaged position. In an engaged position, the override switch 44 is operable to selectively disable the switch 34 and energize the light 32 by electrically connecting the light 32 to the battery 36. In the disengaged position, the override switch 44 is operable to deenergize the light 32 and disable the switch 34. Alternatively, the override switch 44 is a sliding button movable in the direction 50 and is operable to selectively disable the switch 34 and deenergize the light 32 by mechanically engaging a free end of the switch 34 in an engaged position to depress the spring-biased switch 34 and deenergize the light 32. In a disengaged position, the sliding button override switch 44 does not engage the free end of the switch 34 and allows the spring to return the switch 34 to the extended position where the switch 34 electrically connects the battery 36 and the light 32, and thus energizes the light 32.

In FIG. 2, the portable lighting assembly 10 is shown removed from the light housing mount 24 of the container 12. When removed from the container 12, the portable lighting assembly 10 may be advantageously utilized similar to a flashlight to provide illumination therefrom. When the portable lighting assembly 10 is removed from the light housing mount 24, the override switch 44 functions as an on/off switch to selectively provide illumination from the light 32, which advantageously does not require the user of the portable lighting assembly 10 to compress the spring of the switch 34 in order to deenergize the light 32.

Preferably, when the portable lighting assembly 10 is returned to the light housing mount 24, a projection, a flange, or the like (not shown) extending from the container 12 adjacent the light housing mount 24 ensures that the override switch 44 is returned to the disengaged position so that the switch 34 is enabled for use in the container 12.

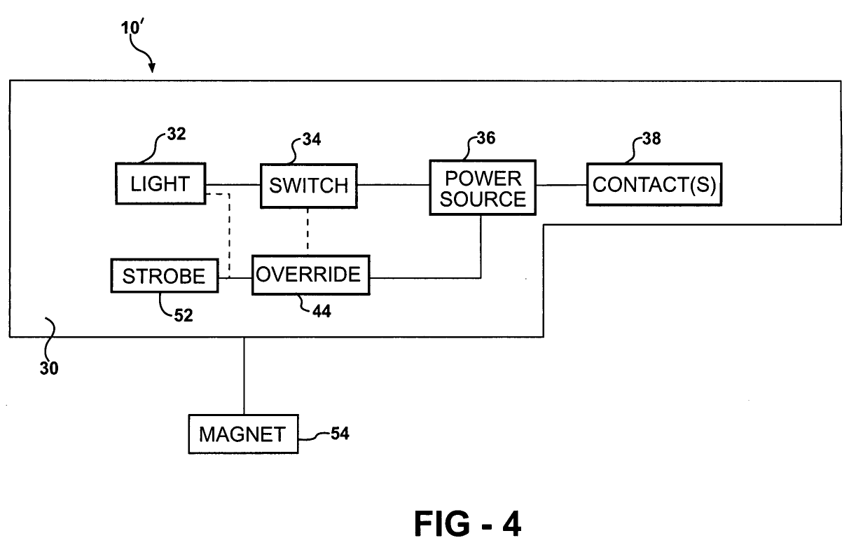

Referring now to FIG. 4, an alternative embodiment of a portable lighting assembly is indicated generally at 10′. The portable lighting assembly 10′ includes the light housing 30 having the light 32, the switch, the battery 36, the contacts 38, and the override switch 44 disposed therein and electrically connected as outlined above. The light housing 30 also includes a strobe light 52 that is electrically connected to the battery 36 through the override switch 44. Preferably, the strobe light 52 is actuated only when the override switch 44 is moved to the engaged position, energizing the strobe light 52 and disabling the switch 32. Alternatively, the override switch 44 includes a pair of engaged positions, one for energizing the light 32 and another for energizing the strobe light 52.

A magnet 54 is attached to an exterior surface of the light housing 30 for placing the portable lighting assembly 10′ on a metallic surface, such as the hood or trunk of the vehicle from which the portable lighting assembly 10′ has been removed. After being placed on the hood or trunk, the strobe light 52 may be activated and the portable lighting assembly 10′ functions as an emergency light while allowing the operator of the vehicle to tend to other tasks. The portable lighting assembly 10′ may also include a red-colored lens, such as the lens 47, attached to the light housing 30 that may be utilized in conjunction with the strobe light 52 to provide a flashing red light to signal distress.

In accordance with the provisions of the patent statutes, the present invention has been described in what is considered to represent its preferred embodiment. However, it should be noted that the invention can be practiced otherwise than as specifically illustrated and described without departing from its spirit or scope.

1. A portable lighting assembly for an automotive vehicle having a container, said container including a moveable door operable to close said container, a light housing mount, and at least one electrical contact connected to a vehicle electric system, comprising:
a light housing having a light and an element for operatively engaging said at least one electrical contact in said container and a power source disposed in said housing and selectively electrically connected to said light and said element in said light housing, said light housing removably mounted to said housing mount, said light housing having a switch operatively engaging said power source and operable to deenergize said light when said door is in a closed position and energize said light when said door is in an open position.

2. The lighting assembly according to claim 1 wherein said power source is removable from said light housing.

3. The lighting assembly according to claim 1 wherein said power source is a rechargeable battery.

4. The lighting assembly according to claim 1 wherein said power source is adapted to be electrically connected to and recharged by said vehicle electrical system when said light housing is disposed in said light housing mount.

5. The lighting assembly according to claim 1 wherein said light housing is adapted to be releasably attached to the vehicle by a retaining member in said light housing mount.

6. The lighting assembly according to claim 1 wherein said switch is attached to said housing and electrically connected to said light and said power source.

7. The lighting assembly according to claim 1 wherein said switch is a spring-biased pushbutton.

8. The lighting assembly according to claim 1 including an override switch attached to said housing and electrically connected to said light and said power source, said override switch having an engaged position and a disengaged position and operable to selectively energize said light and disable said switch in said engaged position and deenergize said light and enable said switch in said disengaged position.

9. The lighting assembly according to claim 1 including an override switch attached to said housing and mechanically engaging said switch, said override switch having an engaged position and a disengaged position and operable to selectively energize said light and enable said switch in said engaged position and deenergize said light and disable said switch in said disengaged position.

10. The lighting assembly according to claim 1 including a lens attached to said light housing adjacent said light.

11. The lighting assembly according to claim 1 including a strobe light disposed in said light housing and electrically connected to said light and selectively connectable to said power source.

12. The lighting assembly according to claim 1 including a magnet attached to said light housing.

13. A portable lighting assembly for an automotive vehicle, comprising:
a container having a moveable door operable to close said container, a light housing mount, and at least one electrical contact connected to a vehicle electric system;
a light housing having a light and an element for operatively engaging said at least one electrical contact in said container and a rechargeable battery disposed in said housing and selectively electrically connected to said light and said element in said light housing, said light housing removably mounted to said housing mount, said light housing having a switch operatively engaging said rechargeable battery and operable to deenergize said light when said door is in a closed position and energize said light when said door is in an open position.

14. The lighting assembly according to claim 13 wherein said rechargeable battery is adapted to be electrically connected to and recharged by said vehicle electrical system when said light housing is disposed in said light housing mount.

15. The lighting assembly according to claim 13 including an override switch attached to said housing and electrically connected to said light and said rechargeable battery, said override switch having an engaged position and a disengaged position and operable to selectively energize said light and disable said switch in said engaged position and deenergize said light and enable said switch in said disengaged position.

16. The lighting assembly according to claim 13 including an override switch attached to said housing and mechanically engaging said switch, said override switch having an engaged position and a disengaged position and operable to selectively energize said light and enable said switch in said engaged position and deenergize said light and disable said switch in said disengaged position.

17. The lighting assembly according to claim 13 wherein said light housing is adapted to be releasably attached to the vehicle by a retaining member in said light housing mount.

18. The lighting assembly according to claim 13 including a strobe light disposed in said light housing and electrically connected to said light and said rechargeable battery.

19. The lighting assembly according to claim 13 including a magnet attached to said light housing.

20. A portable lighting assembly adapted to selectively light a portion of an automobile interior, comprising:
a container having a moveable door operable to close said container, a light housing mount, and at least one electrical contact connected to a vehicle electric system;
a light housing having a light and an element for operatively engaging said at least one electrical contact in said container and a rechargeable battery disposed in said housing and selectively electrically connected to said light and said element in said light housing, said rechargeable battery being removable from said light housing, said light housing removably mounted to said housing mount, said light housing having a switch operatively engaging said rechargeable battery and operable to deenergize said light when said door is in a closed position and energize said light when said door is in an open position, said light housing having an override switch disposed therein and electrically connected to said light and said rechargeable battery, said override switch having an engaged position and a disengaged position and operable to selectively energize said light and disable said switch in said engaged position and deenergize said light and enable said switch in said disengaged position.
